(19) United States
(12) Patent Application Publication
(10) Pub. No.: US 2025/0076673 A1
(43) Pub. Date: Mar. 6, 2025

(54) OPTICAL SYSTEM AND IMAGE PICKUP APPARATUS

(71) Applicant: CANON KABUSHIKI KAISHA, Tokyo (JP)

(72) Inventor: Kentaro MORI, Tochigi (JP)

(21) Appl. No.: 18/815,894

(22) Filed: Aug. 27, 2024

(30) Foreign Application Priority Data
Aug. 31, 2023 (JP) 2023-140612

(51) Int. Cl. G02B 27/42; G02B 1/00; G02B 9/38; G02B 13/00; H04N 23/55

(52) U.S. Cl. CPC G02B 27/4211; G02B 1/002; G02B 13/004; G02B 9/38; H04N 23/55

(57) ABSTRACT

An optical system includes, in order from an object side to an image side, a diffractive optical element having positive refractive power, and a diffractive surface with a controlled wavelength dispersion characteristic, and a lens having negative refractive power. A predetermined inequality is satisfied.

### BACKGROUND

### Technical Field

One of the aspects of the embodiments relates to an optical system suitable for an image pickup apparatus, such as a digital camera.

### Description of Related Art

As an optical system for a small camera mounted on a smartphone, U.S. Pat. No. 10,989,901 discloses a telephoto type optical system that consists of six lenses, in which a first lens having strong positive refractive power is disposed closest to an object. US Patent Publication No. 2021/0132256 discloses an optical system that consists of a first lens having positive refractive power and a convex shape toward an object side and disposed closest to an object, and a second lens having negative chromatic aberration including a metasurface lens. International Patent Publication No. WO2021/170417 discloses an optical system that includes a first lens that has strong positive refractive power and is disposed closest to the object, and a diffractive optical element (DOE) having at least one surface with an uncontrolled wavelength dispersion characteristic, wherein a focal length and an overall length of the optical system, and a focal length of the DOE are properly set for size reduction.

These optical systems include a first lens having strong positive refractive power and disposed closest to the object. This configuration is effective in reducing the overall length of the optical system, but the first lens generates large chromatic aberration and monochromatic aberration, and thus multiple lenses including an aspheric lens having negative refractive power correct various aberrations such as chromatic aberration.

In a case where the first lens has strong positive refractive power to reduce the overall length and correct aberrations with a small number of lenses, it is effective to use a diffractive surface having a negative Abbe number mainly to correct chromatic aberration. However, the Abbe number of a normal diffractive surface having an uncontrolled wavelength dispersion characteristic shows extremely high dispersion, and thus this diffractive surface having refractive power (the reciprocal of the focal length) generates large chromatic aberration. Thus, it is difficult to achieve both a compact optical system and high image quality by reducing the number of lenses.

### SUMMARY

An optical system according to one aspect of the disclosure includes, in order from an object side to an image side, a diffractive optical element having positive refractive power, and a diffractive surface with a controlled wavelength dispersion characteristic, and a lens having negative refractive power. Where ν₀ is an Abbe number of the diffractive surface, a reference wavelength is d-line, primary dispersion is F-line and C-line, Ψ(λ_{d}), Ψ(λ_{F}), and Ψ(λ_{C}) are optical path difference functions for the d-line, the F-line, and the C-line, respectively, P(λ_{d}), P(λ_{F}), and P(λ_{C}) are optical path difference dispersions of a surface for the d-line, the F-line, and the C-line, respectively the following equation is satisfied:

$$\frac{1}{{v}_{o}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} ,$$

and the following inequality is satisfied:

$$- 0.2 < 1 / {v}_{0} < 0.2 .$$

An optical system according to another aspect of the disclosure includes, in order from an object side to an image side, a metalens having positive refractive power, and a metasurface with a controlled wavelength dispersion characteristic, and a lens having negative refractive power. Where ν₀ is an Abbe number of the metasurface, a reference wavelength is d-line, primary dispersion is F-line and C-line, Ψ(λ_{d}), Ψ(λ_{F}), and Ψ(λ_{C}) are optical path difference functions for the d-line, the F-line, and the C-line, respectively, P(λ_{d}), P(λ_{F}), and P(λ_{C}) are optical path difference dispersions of a surface for the d-line, the F-line, and the C-line, respectively, the following equation is satisfied:

$$\frac{1}{{v}_{o}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} ,$$

and the following inequality is satisfied:

$$- 0.2 < 1 / {v}_{0} < 0.2 .$$

An image pickup apparatus having each of the above optical systems also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of an optical system according to Example 5.

FIG. 10 is an aberration diagram of the optical system according to Example 5.

FIG. 11 is a diagram illustrating an image pickup apparatus using the optical system according to any one of the above examples.

### DESCRIPTION OF THE EMBODIMENTS

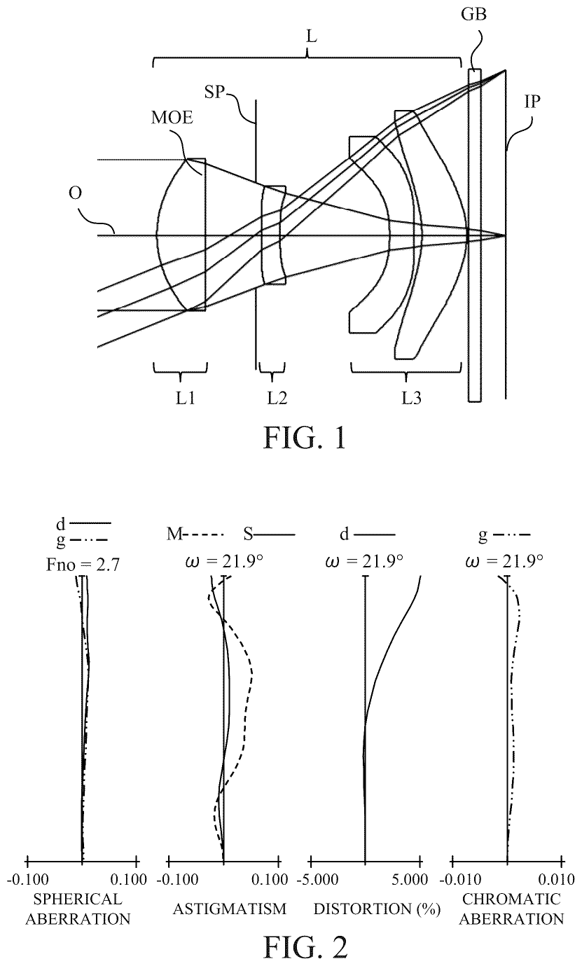

Referring now to the accompanying drawings, a description will be given of embodiments according to the disclosure. A description will now be given of matters common to each example before specific Examples 1 to 5 are described. FIGS. 1, 3, 5, 7, and 9 illustrate the configurations of optical systems L according to Examples 1 to 5, respectively. O represents an optical axis of the optical system L. MOE represents a diffractive optical element (DOE) including a diffractive surface with a controlled wavelength dispersion characteristic (simply referred to as controlled dispersion hereinafter). L1 represents a first lens, L2 represents a second lens, and L3 represents a third lens unit. SP represents an aperture stop (diaphragm), and GB represents a glass block including an infrared cut filter, a low-pass filter, etc. IP represents an image plane of the optical system L. Disposed on the image plane IP is an imaging surface (light receiving surface) of an image sensor such as a CCD sensor or a CMOS sensor, or a film plane (photosensitive surface) of a silver film. FIGS. 2, 4, 6, 8, and 10 respectively illustrate longitudinal aberration diagrams (spherical aberration, astigmatism, distortion, and chromatic aberration) of the optical systems according to numerical examples 1 to 5 corresponding to Examples 1 to 5 in an in-focus state on an object at infinity (referred to as “in the in-focus state at infinity” hereinafter). A vertical axis Fno of each spherical aberration diagram represents an F-number, and a vertical axis ω of each of the astigmatism, distortion, and chromatic aberration represents a half angle of view (°). A horizontal axis represents a corresponding aberration amount.

In the spherical aberration diagram, a solid line represents a spherical aberration amount for the d-line (wavelength 587.6 nm), and an alternate long and two short dashes line represents a spherical aberration for the g-line (wavelength 435.8 nm). In the astigmatism diagram, a solid line S represents an astigmatism amount on a sagittal image plane, and a dashed line M represents an astigmatism amount on a meridional image plane. The distortion diagrams illustrate a distortion amount for the d-line. The chromatic aberration diagram illustrates a lateral chromatic aberration amount for the g-line.

A description will now be given of the characteristics of the optical system according to each example, which has a reduced size, high optical performance, and a small number of lenses.

The optical system according to each example includes, in order from the object side to the image side, a DOE having positive refractive power and a convex refractive surface on the object side and a dispersion-controlled diffractive surface on the image side, and a lens having negative refractive power. A lens or another optical element may be disposed on the object side of the DOE. The following inequality (1) is satisfied:

$$- 0.2 < 1 / {v}_{0} < 0.2 \qquad ( 1 )$$

where ν₀ is an Abbe number of the diffractive surface.

The Abbe number ν₀ of the dispersion-controlled diffractive surface is defined by the following equation:

$$\frac{1}{{v}_{o}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )}$$

Here, the reference wavelength is the d-line (λ_{d}=0.58756 μm), the primary dispersion is the F-line (λ_{F}=0.48613 μm) and the C-line (λ_{C}=0.65627 μm), and Ψ(λ_{d}), Ψ(λ_{F}), and Ψ(λ_{C}) are optical path difference functions for the respective wavelengths. P(λ_{d}), P(λ_{F}), and P(λ_{C}) are optical path difference dispersion of the surface for the respective wavelengths.

As described above, the optical system according to each example includes a DOE having positive refractive power, a convex refractive surface on the object side, and a dispersion-controlled diffractive surface on the image side. The convergence effect of the light rays due to the positive refractive power promotes a reduced size of the optical system. The dispersion-controlled diffractive surface can effectively correct chromatic aberration and provide high optical performance with a small number of lenses.

In addition, the optical system according to each example includes a second lens having negative refractive power. The second lens can promote high optical performance by correcting various aberrations, mainly monochromatic aberrations, generated in a DOE having positive refractive power.

Inequality (1) defines a condition for effectively correcting chromatic aberration with a dispersion-controlled diffractive surface and for providing high optical performance with a small number of lenses. In a case where the negative Abbe number becomes too highly dispersed so that 1/ν₀ becomes lower than the lower limit of inequality (1), the chromatic aberration generated by the dispersion-controlled diffractive surface becomes too large, it becomes difficult to increase the refractive power of the diffractive surface and to reduce the size of the optical system. It also becomes difficult to correct chromatic aberration, and to provide high optical performance. In a case where the positive Abbe number becomes too highly dispersed so that 1/ν₀ becomes higher than the upper limit of inequality (1), the chromatic aberration generated by the dispersion-controlled diffractive surface becomes too large, and it becomes difficult to increase the refractive power of the diffractive surface and to reduce the size of the optical system. It also becomes difficult to correct chromatic aberration, and to provide high optical performance.

Inequality (1) may be replaced with inequality (1a) below:

$$- 0.10 < 1 / {v}_{0} < 0.02 \qquad ( 1 a )$$

Inequality (1) may be replaced with inequality (1b) below:

$$- 0.100 < 1 / {v}_{0} < 0.01 \qquad ( 1 b )$$

The optical system according to each example may satisfy at least one of the following inequalities (2) to (8).

The following inequality (2) may be satisfied:

$$0.3 < f 1 / f < 0.8 \qquad ( 2 )$$

where f1 is a focal length of a DOE having positive refractive power, and f is a focal length of the entire optical system.

Inequality (2) defines a condition for easily providing an optical system that has a reduced size and high optical performance. In a case where f1/f becomes lower than the lower limit of inequality (2), the focal length of the DOE becomes too short, and it becomes difficult to provide high optical performance. In a case where f1/f becomes higher than the upper limit of inequality (2), the focal length of the DOE becomes too long, and it becomes difficult to reduce the size of the optical system.

Inequality (2) may be replaced with inequality (2a) below:

$$0.4 < f 1 / f < 0.7 \qquad ( 2 a )$$

Inequality (2) may be replaced with inequality (2b) below:

$$0. 45 < f l / f < 0.65 \qquad ( 2 b )$$

The following inequality (3) may be satisfied:

$$2.5 < {f}_{m o e} / f < 10.0 \qquad ( 3 )$$

where fₘₒₑ is a focal length of the dispersion-controlled diffractive surface, and fis a focal length of the entire optical system.

The focal length fₘₒₑ of the dispersion-controlled diffractive surface is calculated by the following equation:

$$\frac{1}{{f}_{moe}} = - 2 {U}_{2}$$

where U₂ is a quadratic coefficient of the optical path difference function of the surface at a design wavelength.

Inequality (3) defines a condition for easily providing an optical system having a reduced size and high optical performance. In a case where fₘₒₑ/f becomes lower than the lower limit of inequality (3), the focal length of the dispersion-controlled diffractive surface becomes too short, large aberrations are generated such as spherical aberration, and it becomes difficult to achieve high optical performance. In a case where fₘₒₑ/f becomes higher than the upper limit of inequality (3), the focal length of the dispersion-controlled diffractive surface becomes too long, and it becomes difficult to reduce the size of the optical system.

Inequality (3) may be replaced with inequality (3a) below:

$$3. < {f}_{m o e} / f < 9.7 \qquad ( 3 a )$$

Inequality (3) may be replaced with inequality (3b) below:

$$4. < {f}_{m o e} / f < 9.4 \qquad ( 3 b )$$

The following inequality (4) may be satisfied:

$$0.6 < TL / f < 0.9 \qquad ( 4 )$$

where TL is a distance on the optical axis from a lens surface closest to the object to the image surface (referred to as the overall lens length hereinafter).

Inequality (4) defines a condition for easily providing an optical system that has a reduced size and high optical performance. In a case where TL/f becomes lower than the lower limit of inequality (4), the overall lens length becomes too short, large aberrations are generated such as spherical aberration, and it becomes difficult to obtain high optical performance. In a case where TL/f becomes higher than the upper limit of inequality (4), the overall lens length becomes too long, and it becomes difficult to reduce the size of the optical system.

Inequality (4) may be replaced with inequality (4a) below:

$$0.7 < TL / f < 0.88 \qquad ( 4 a )$$

Inequality (4) may be replaced with inequality (4b) below:

$$0.75 < TL / f < 0.86 \qquad ( 4 b )$$

The optical system according to each example may include, in order from the object side to the image side, a first optical element (referred to as a first DOE hereinafter) as a DOE having positive refractive power described above (and disposed closest to the object), and a second optical element (referred to as the second lens hereinafter) as a lens having negative refractive power described above. As described above, the first DOE is a DOE having positive refractive power, a convex refractive surface on the object side, and a dispersion-controlled diffractive surface on the image side. Due to this arrangement, the first DOE can effectively converge light rays while properly correcting various aberrations such as chromatic aberration. The second lens having negative refractive power can easily provide high optical performance by correcting various aberrations, mainly monochromatic aberrations, generated by the DOE having positive refractive power.

The following inequality (5) may be satisfied:

$$0.08 < D 12 / TL < 0.40 \qquad ( 5 )$$

where D12 is an air gap on the optical axis between the first DOE having positive refractive power and the second lens having negative refractive power.

Inequality (5) defines a condition for easily providing an optical system that has a reduced size and high optical performance. In a case where the air gap D12 is too short so that D12/TL becomes lower than the lower limit of inequality (5), it becomes difficult to sufficiently converge the on-axis marginal ray by the first DOE and make it enter the second lens. As a result, it becomes difficult to obtain high optical performance by correcting various aberrations such as spherical aberration and coma by giving strong negative refractive power to the second lens. In a case where the air gap D12 is too long so that D12/TL becomes higher than the upper limit of inequality (5), it becomes difficult to reduce the size of the optical system.

Inequality (5) may be replaced with inequality (5a) below:

$$0.1 < D 12 / TL < 0.30 \qquad ( 5 a )$$

Inequality (5) may be replaced with inequality (5b) below:

$$0.11 < D 12 / TL < 0.25 \qquad ( 5 b )$$

The following inequality (6) may be satisfied:

$$0.15 < D 23 / TL < 0.50 \qquad ( 6 )$$

where D23 is an air gap on the optical axis between the second lens having negative refractive power and the third optical element (referred to as the third lens hereinafter) serving as a lens disposed on the image side of and adjacent to the second lens.

Inequality (6) defines a condition for easily providing an optical system that has a reduced size and high optical performance. In a case where the air gap D23 becomes too short so that D23/TL becomes lower than the lower limit of inequality (6), it becomes difficult to sufficiently separate an off-axis light beam incident on the third lens. As a result, it becomes difficult to effectively utilize an aspheric surface of the third lens to correct aberrations, and to provide high optical performance. In a case where the air gap D23 becomes too long so that D23/TL becomes higher than the upper limit of inequality (6), it becomes difficult to reduce the size of the optical system.

Inequality (6) may be replaced with inequality (6a) below:

$$0.18 < D 23 / TL < 0.40 \qquad ( 6 a )$$

Inequality (6) may be replaced with inequality (6b) below:

$$0.2 < D 23 / TL < 0.35 \qquad ( 6 b )$$

The following inequality (7) may be satisfied:

$$0. 20 < L 02 / TL < 0.45 \qquad ( 7 )$$

where L02 is a distance on the optical axis from a lens surface closest to the object of the optical system to a lens surface closest to the object of the second lens.

Inequality (7) defines a condition for easily providing an optical system with high optical performance. In a case where the distance L02 becomes too short so that L02/TL becomes lower than the lower limit of inequality (7), the second lens becomes excessively close to the first lens. As a result, it becomes difficult to make the entire optical system have a concentric shape with respect to the second lens as a center, and it becomes difficult to correct various aberrations, such as curvature of field and distortion. In a case where the distance L02 becomes too long so that L02/TL becomes higher than the upper limit of inequality (7), the second lens becomes excessively close to the lens on the image side. As a result, it becomes difficult to make the entire optical system have a concentric shape with respect to the second lens as a center, and it becomes difficult to correct the various aberrations, such as curvature of field and distortion.

Inequality (7) may be replaced with inequality (7a) below:

$$0. 24 < L 02 / TL < 0.40 \qquad ( 7 a )$$

Inequality (7) may be replaced with inequality (7b) below:

$$0. 26 < L 02 / TL < 0.36 \qquad ( 7 b )$$

The following inequality (8) may be satisfied:

$$- 1.5 < fG 3 / f < - 0.4 \qquad ( 8 )$$

where fG3 is a focal length of the third lens having negative refractive power disposed on the image side of and adjacent to the second lens having negative refractive power.

Inequality (8) defines a condition for easily providing an optical system that has a reduced size and high optical performance. In a case where the focal length fG3 is too long so that fG3/f becomes lower than the lower limit of inequality (8), the effect of changing a light ray direction of the third lens becomes too weak, and it becomes difficult for the third lens to effectively correct various aberrations such as curvature of field and distortion. In a case where the focal length fG3 becomes too short so that fG3/f becomes higher than the upper limit of inequality (8), a light divergence effect of the third lens becomes too strong, and it becomes difficult to reduce the overall length of the optical system.

Inequality (8) may be replaced with inequality (8a) below:

$$- 1. < fG 3 / f < - 0.5 \qquad ( 8 a )$$

Inequality (8) may be replaced with inequality (8b) below:

$$- 0.70 < fG 3 / f < - 0.55 \qquad ( 8 b )$$

The optical system according to each example may include, in order from the object side to the image side, a first DOE having positive refractive power (and disposed closest to the object), a second lens having negative refractive power, a third lens having aspheric surfaces on both sides, and a fourth optical element (fourth lens) having aspheric surfaces on both sides.

The first DOE having positive refractive power and the second lens having negative refractive power arranged in order from the object side can effectively converge the light rays with the first DOE and properly correct various aberrations such as chromatic aberration. The second lens having negative refractive power next to the first DOE having positive refractive power can easily provide high optical performance by correcting various aberrations, mainly monochromatic aberrations, generated by the first DOE. The third lens having aspheric surfaces on both sides and a fourth lens having aspheric surfaces on both sides can provide high optical performance with a small number of lenses, that is, four.

A specific description will now be given of the optical systems L according to Examples 1 to 5. After Example 5, numerical examples 1 to 5 corresponding to Examples 1 to 5, respectively, will be illustrated.

In each numerical example, a surface number i represents the order of the surfaces counted from the object side. r represents a paraxial radius of curvature (mm) of an i-th optical surface (i-th surface), and d represents an on-axis distance (lens thickness or air gap) (mm) along the optical axis between i-th and (i+1)-th surfaces. nd and vd respectively represent a refractive index for the d-line of the material of the i-th optical member, and the Abbe number based on the d-line.

The Abbe number vd based on the d-line is expressed as:

$$v d = ( N d - 1 ) / ( NF - N C )$$

where Nd, NF, and NC are the refractive indices for the d-line (587.6 nm), F-line (486.1 nm), and C-line (656.3 nm) in the Fraunhofer line. An effective diameter represents a radius (mm) of an area on the i-th surface through which the light rays that contribute to imaging pass.

BF represents a back focus (mm). The back focus is a distance on the optical axis from the final surface of the zoom lens (the lens surface closest to the image plane) to a paraxial image surface, expressed by an air equivalent length. The overall lens length is a distance on the optical axis from the frontmost surface of the zoom lens (the lens surface closest to the object) to the final surface plus the back focus, and corresponds to TL in inequalities (4) to (7).

An asterisk “*” attached to a surface number means that the surface has an aspherical shape. The aspherical shape is expressed by the following expression:

$$x = ( {h}^{2} / R ) / [ 1 + {\{ 1 - ( 1 + k ) {( h / R )}^{2} \}}^{1 / 2} ] + A 4 \cdot {h}^{4} + A 6 \cdot {h}^{6} + A 8 \cdot {h}^{8} + A 10 \cdot {h}^{10}$$

where x is a displacement amount from a surface vertex in the optical axis direction, h is a height from the optical axis in a direction orthogonal to the optical axis, a light traveling direction is set positive, R is a paraxial radius of curvature, k is a conic constant, and A4 to A10 are aspheric coefficients. e±M in the conic constant and aspheric coefficients means ×10^{±M}.

The optical path difference function of the surface at the design wavelength is expressed by the following expression:

$$ψ 0 = U 2 \cdot {h}^{2} + U 4 \cdot {h}^{4} + U 6 \cdot {h}^{6} + U 8 \cdot {h}^{8} + U 10 \cdot {h}^{10}$$

where U2 to U10 are optical path difference function coefficients of the surface.

The (diffraction) attached to the surface number represents an optically designed surface using the optical path difference function of the surface.

Table 1 summarizes values relating to inequalities (1) to (8) for numerical examples 1 to 5.

### EXAMPLE 1

The optical system L according to Example 1 (numerical example 1) illustrated in FIG. 1 is an optical system having a focal length of 6.79 mm, an F-number of 2.7, and a half angle of view of 21.83°. The optical system L includes, in this order from the object side to the image side, a first DOE L1 having positive refractive power, an aperture stop SP, a second lens L2 having negative refractive power, and a third lens unit L3.

The first DOE L1 is a DOE having a convex refractive surface on the object side and a dispersion-controlled diffractive surface on the image side. The second lens L2 has aspheric surfaces on both sides and paraxial biconcave lens surfaces. The third lens unit L3 includes, in order from the object side to the image side, a third lens having negative refractive power, paraxial biconcave lens surfaces, and aspheric surfaces on both sides, and a fourth lens having positive refractive power, a paraxial meniscus shape that is convex on the image side, and aspheric surfaces on both sides.

### EXAMPLE 2

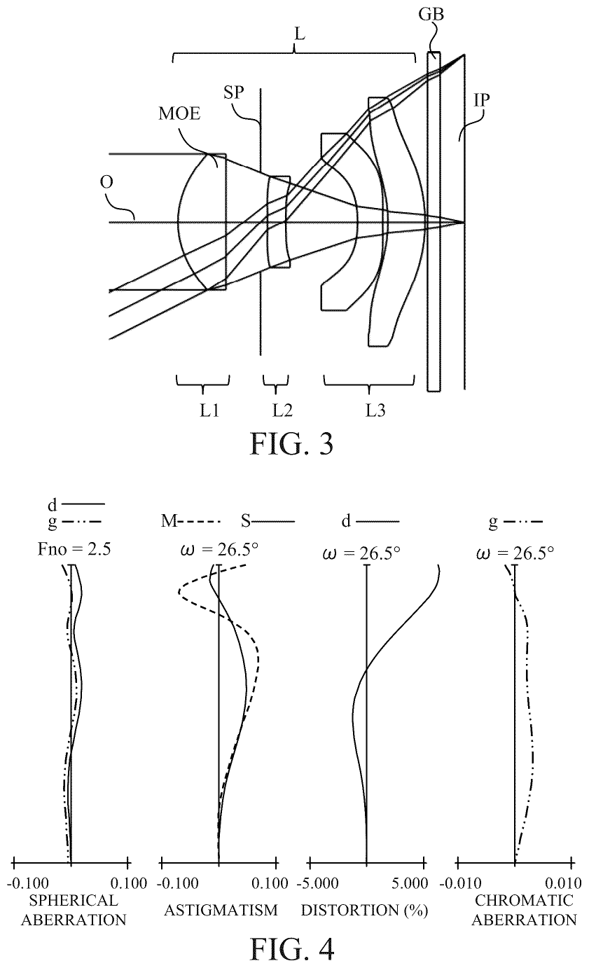

The optical system L according to Example 2 (numerical example 2) illustrated in FIG. 3 is an optical system having a focal length of 5.53 mm, an F-number of 2.5, and a half angle of view of 26.2°. The optical system L includes, in this order from the object side to the image side, a first DOE L1 having positive refractive power, an aperture stop SP, a second lens L2 having negative refractive power, and a third lens unit L3.

The first DOE L1 is a DOE having a convex refractive surface on the object side and a dispersion-controlled diffractive surface on the image side. The second lens L2 has aspheric surfaces on both sides and paraxial biconcave lens surfaces. The third lens unit L3 includes, in order from the object side to the image side, a third lens having negative refractive power, paraxial biconcave lens surfaces, and aspheric surfaces on both sides, and a fourth lens having negative refractive power, a paraxial meniscus shape that is convex on the image side, and aspheric surfaces on both sides.

### EXAMPLE 3

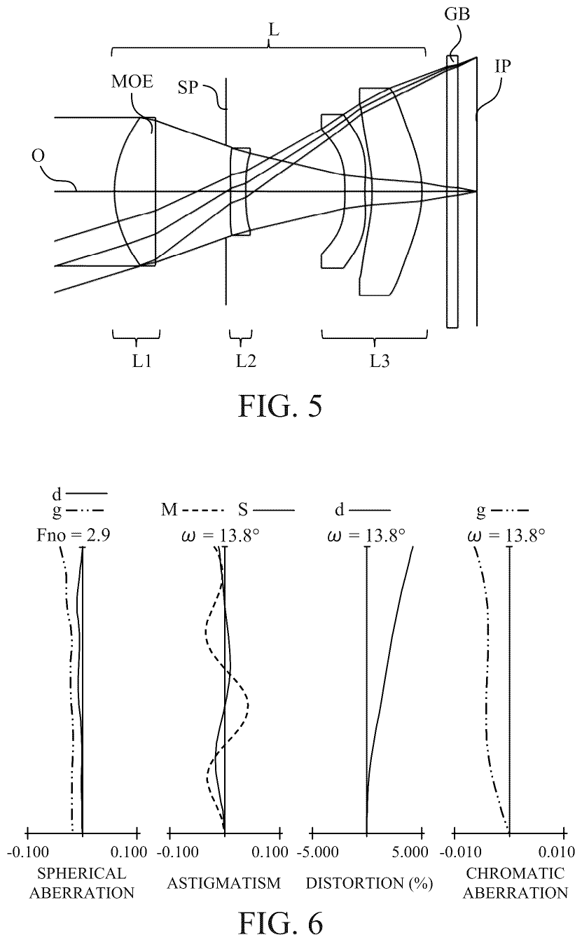

The optical system L according to Example 3 (numerical example 3) illustrated in FIG. 5 is an optical system having a focal length of 8.70 mm, an F-number of 2.9, and a half angle of view of 17.36°. The optical system L includes, in this order from the object side to the image side, a first DOE L1 having positive refractive power, an aperture stop SP, a second lens L2 having negative refractive power, and a third lens unit L3.

The first DOE 1 is a DOE having a convex refractive surface on the object side and a dispersion-controlled diffractive surface on the image side. The second lens L2 has aspheric surfaces on both sides and paraxial biconcave lens surfaces. The third lens unit L3 includes, in order from the object side to the image side, a third lens having negative refractive power, paraxial biconcave lens surfaces, and aspheric surfaces on both sides, a fourth lens having positive refractive power, a paraxial meniscus shape that is convex on the image side, and aspheric surfaces on both sides.

### EXAMPLE 4

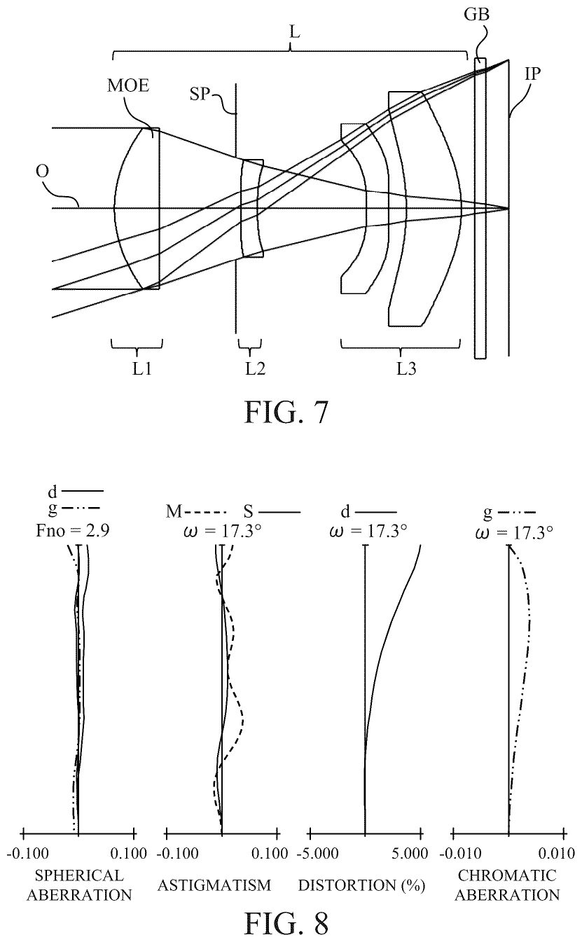

The optical system L according to Example 4 (numerical example 4) illustrated in FIG. 7 is an optical system having a focal length of 8.58 mm, an F-number of 2.9, and a half angle of view of 17.59°. The optical system L includes, in this order from the object side to the image side, a first DOE L1 having positive refractive power, an aperture stop SP, a second lens L2 having negative refractive power, and a third lens unit L3.

Similarly to Example 1, the first DOE L1 is a DOE having a convex refractive surface on the object side and a dispersion-controlled diffractive surface on the image side. The second lens L2 has aspheric surfaces on both sides and paraxial biconcave lens surfaces. The third lens unit L3 includes, in this order from the object side to the image side, a third lens having negative refractive power, paraxial biconcave lens surfaces, and aspheric surfaces on both sides, and a fourth lens having positive refractive power, a paraxial meniscus shape that is convex on the image side, and aspheric surfaces on both sides.

### EXAMPLE 5

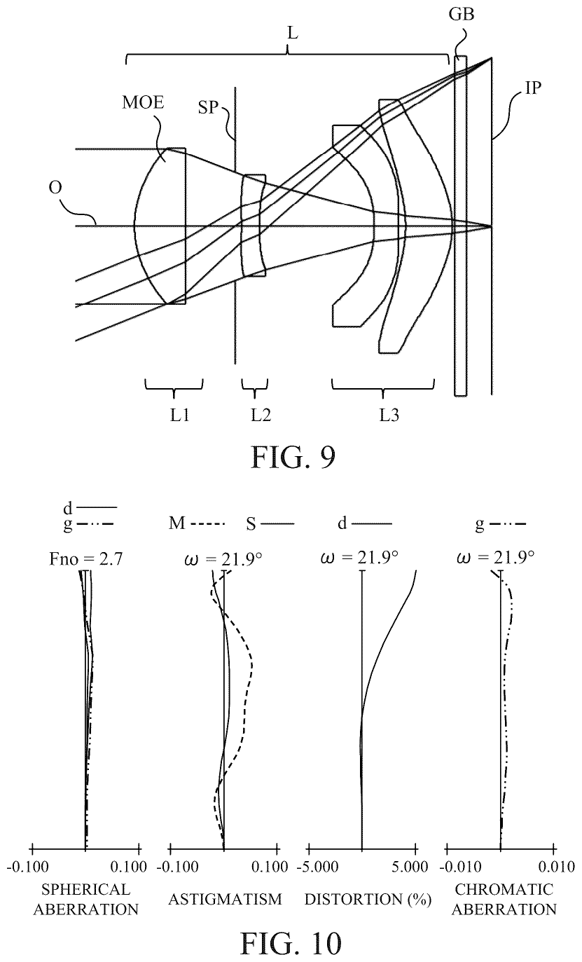

The optical system L according to Example 5 (numerical example 5) illustrated in FIG. 9 is an optical system having a focal length of 6.79 mm, an F-number of 2.7, and a half angle of view of 21.83°. The optical system L includes, in this order from the object side to the image side, a first DOE L1 having positive refractive power, an aperture stop SP, a second lens L2 having negative refractive power, and a third lens unit L3.

Similarly to Example 1, the first DOE L1 is a DOE having a convex refractive surface on the object side and a dispersion-controlled diffractive surface on the image side. The second lens L2 has aspheric surfaces on both sides and paraxial biconcave lens surfaces. The third lens unit L3 includes, in this order from the object side to the image side, a third lens having negative refractive power, paraxial biconcave lens surfaces, and aspheric surfaces on both sides, and a fourth lens having positive refractive power, a paraxial meniscus shape that is convex on the image side, and aspheric surfaces on both sides.

In imaging using the optical system L according to each example, aberration correction may be performed by image processing. The optical path difference function of the DOE may be realized by a metalens having a so-called single-layer metasurface, in which the metasurface consists of a single layer, or a so-called layered metasurface, in which the metasurface includes a plurality of layers. In this case, the metalens has a positive refractive power and a metasurface with a controlled wavelength dispersion characteristic. The metalens may have a convex refractive surface on the object side and the metasurface may be disposed on the image side of the metalens.

### NUMERICAL EXAMPLE 1

UNIT: mm
SURFACE DATA

| | | | | | Effective |
|---|---|---|---|---|---|
| Surface No. | r | d | nd | vd | Diameter |
| 1* | 1.684 | 0.81 | 1.43875 | 94.9 | 2.51 |
| 2 (diffraction) | ∞ | 0.83 | | | 2.37 |
| 3 (SP) | ∞ | 0.10 | | | 1.74 |
| 4* | −9.488 | 0.30 | 1.59946 | 25.8 | 1.63 |
| 5* | 7.691 | 1.82 | | | 1.39 |
| 6* | −2.930 | 0.40 | 1.53504 | 55.7 | 2.56 |
| 7* | 12.835 | 0.12 | | | 3.25 |
| 8* | −1.910 | 0.74 | 1.64025 | 19.3 | 3.75 |
| 9* | −1.431 | 0.03 | | | 4.11 |
| 10 | ∞ | 0.21 | 1.51633 | 64.1 | 5.50 |
| 11 | ∞ | 0.40 | | | 5.50 |
| Image Plane | ∞ | | | | |

### Aspheric Data

$$\begin{matrix}1 st Surface \\ \begin{matrix}K = - 8.37714 e - 01 & A 4 = 9. 67558 e - 03 & A 6 = - 6.23630 e - 04 & A 8 = 2. 13482 e - 03 \\ A 10 = - 8.44847 e - 04 & & & \end{matrix}\end{matrix}$$

$$\begin{matrix}2 nd Surface ( diffractive surface ) \\ \begin{matrix}Designed Wavelength & 0.58756 [ μm ]\end{matrix} \\ \begin{matrix}U 2 = - 9.76396 e - 03 & U 4 = 1.4616 e - 03 & U 6 = 1.78901 e - 03 & U 8 = - 1.02999 e - 03 \\ U 10 = 1.12524 e - 04 & & & \end{matrix}\end{matrix}$$

### Optical Path Difference Dispersion of Surface

$$P ( λ ) = 12.24651 \cdot {λ}^{10} - 119.47 \; 404 \cdot {λ}^{9} + 698.934 \cdot {λ}^{8} - 2720.50 \; 548 \cdot {λ}^{7} + 7400.16 \; 189 \cdot {λ}^{6} - 14357.25933 \cdot {λ}^{5} + 19873.45822 \cdot {λ}^{4} - 1924 \; 0.96 \; 797 \cdot {λ}^{3} + 19240.96797 \cdot {λ}^{2} - 4807. 97 \; 026 \cdot λ + 847.4701$$

$$\begin{matrix}P ( {λ}_{d} ) = 1. e + 00 \\ P ( {λ}_{C} ) = 9.061342 e - 01 \\ P ( {λ}_{F} ) = 1.194911 e + 00\end{matrix}$$

$$\begin{matrix}4 th Surface \\ \begin{matrix}K = - 7.30312 e + 02 & A 4 = 1. 11548 e - 01 & A 6 = 2. 68473 e - 01 & A 8 = - 1.02096 e + 00\end{matrix} \\ \begin{matrix}A 10 = 2.20808 e + 00 & A 12 = - 2. 77979 e + 00 & A 14 = 1.80491 e + 00 & A 16 = - 4. 29895 e - 01\end{matrix}\end{matrix}$$

$$\begin{matrix}5 th Surface \\ \begin{matrix}K = 9.5 0000 e + 01 & A 4 = 2. 50245 e - 01 & A 6 = - 9.99304 e - 02 & A 8 = 1.82022 e - 01\end{matrix} \\ A 10 = - 2.06303 e - 01\end{matrix}$$

$$\begin{matrix}6 th Surface \\ \begin{matrix}K = 3.71573 e + 00 & A 4 = - 3.10316 e - 01 & A 6 = - 1.39954 e - 01 & A 8 = 1.08852 e + 00\end{matrix} \\ \begin{matrix}A 10 = - 1.59622 e + 00 & A 12 = 1.13582 e + 00 & A 14 = - 4. 07725 e - 01 & A 16 = 6.09779 e - 02\end{matrix}\end{matrix}$$

$$\begin{matrix}7 th Surface \\ \begin{matrix}K = 5.66804 e + 01 & A 4 = - 3.59989 e - 01 & A 6 = 2. 81360 e - 01 & A 8 = - 1.32968 e - 01\end{matrix} \\ \begin{matrix}A 10 = 3.0041 e - 02 & A 12 = - 3.0355 e - 03 & A 14 = 1.94204 e - 04\end{matrix}\end{matrix}$$

$$\begin{matrix}8 th Surface \\ \begin{matrix}K = - 7.61381 e + 00 & A 4 = 2.25923 e - 02 & A 6 = - 1.53447 e - 02 & A 8 = 1.29023 e - 03\end{matrix} \\ \begin{matrix}A 10 = 1.54 e - 03 & A 12 = - 3.07319 e - 04\end{matrix}\end{matrix}$$

$$\begin{matrix}9 th Surface \\ \begin{matrix}K = - 3.68987 e + 00 & A 4 = - 2.79819 e - 03 & A 6 = - 1.52162 e - 03 & A 8 = - 3.47584 e - 03\end{matrix} \\ \begin{matrix}A 10 = 2.02821 e - 03 & A 12 = - 2. 65856 e - 04\end{matrix}\end{matrix}$$

VARIOUS DATA

| | |
|---|---|
| Focal Length | 6.79 |
| Fno | 2.70 |
| Half Angle of View (°) | 21.83 |
| Image Height | 2.72 |
| Overall Lens Length | 5.69 |
| BF | 0.57 |
| Entrance Pupil Position | 2.21 |
| Exit Pupil Position | −5.42 |
| Front Principal-Point Position | 1.08 |
| Rear Principal-Point Position | −6.39 |

SINGLE LENS DATA

| | Starting | Focal |
|---|---|---|
| Lens | Surface | Length |
| 1 | 1 | 3.61 |
| 2 | 4 | −7.04 |
| 3 | 6 | −4.42 |
| 4 | 8 | 5.55 |

### NUMERICAL EXAMPLE 2

UNIT: mm
SURFACE DATA

| | | | | | Effective |
|---|---|---|---|---|---|
| Surface No. | r | d | nd | vd | Diameter |
| 1* | 1.386 | 0.77 | 1.43875 | 94.9 | 2.21 |
| 2 (diffraction) | ∞ | 0.57 | | | 2.06 |
| 3 (SP) | ∞ | 0.11 | | | 1.60 |
| 4* | −10.233 | 0.30 | 1.60586 | 24.5 | 1.48 |
| 5* | 11.746 | 1.17 | | | 1.25 |
| 6* | −2.121 | 0.40 | 1.53504 | 55.7 | 2.08 |
| 7* | 12.818 | 0.09 | | | 2.88 |
| 8* | −2.090 | 0.61 | 1.63085 | 20.4 | 3.65 |
| 9* | −2.454 | 0.03 | | | 4.06 |
| 10 | ∞ | 0.21 | 1.51633 | 64.1 | 5.50 |
| 11 | ∞ | 0.40 | | | 5.50 |

| | |
|---|---|
| Image Plane | ∞ |

### Aspheric Data

### 1st Surface

$$\begin{matrix}K = - 9.18376 e - 01 & A 4 = 1.89471 e - 02 & A 6 = 1.09143 e - 03 & A 8 = 1.87832 e - 03 \\ A 10 = - 2.95422 e - 03 & & & \end{matrix}$$

$$\begin{matrix}2 nd Surface ( Diffractive surface ) \\ \begin{matrix}Designed Wavelength & 0.58756 [ μm ]\end{matrix} \\ \begin{matrix}U 2 = - 1.00142 e - 02 & U 4 = 7.40658 e - 03 & U 6 = - 1.02452 e - 02 & U 8 = 7.55762 e - 03 \\ U 10 = - 2.62698 e - 03 & & & \end{matrix}\end{matrix}$$

### Optical Path Difference Dispersion of Surface

$$P ( λ ) = 13.87 546 \cdot {λ}^{10} - 153.95668 \cdot {λ}^{9} + 1009.95 \; 630 \cdot {λ}^{8} - 4356.52716 \cdot {λ}^{7} + 1300 \; 6.44 \; 877 \cdot {λ}^{6} - 2747 \; 0.79 \; 737 \cdot {λ}^{5} + 4110 \; 6.88 \; 437 \cdot {λ}^{4} - 42762.08537 \cdot {λ}^{3} + 29486.82651 \cdot {λ}^{2} - 1214 \; 4.39 \; 247 \cdot λ + 226 \; 6 \text{.41068}$$

$$\begin{matrix}P ( {λ}_{d} ) = 1. e + 00 \\ P ( {λ}_{C} ) = 9.155559 e - 01 \\ P ( {λ}_{F} ) = 1.184181 e + 00\end{matrix}$$

$$\begin{matrix}4 th Surface \\ \begin{matrix}K = - 2.71665 e + 02 & A 4 = 2.02763 e - 01 & A 6 = - 7.20641 e - 02 & A 8 = 8.04897 e - 01\end{matrix} \\ \begin{matrix}A 10 = - 3.05427 e + 00 & A 12 = 5.29501 e + 00 & A 14 = - 4.1421 e + 00 & A 16 = 1.19528 e + 00\end{matrix}\end{matrix}$$

$$\begin{matrix}5 th Surface \\ \begin{matrix}K = 4.89253 e - 01 & A 4 = 2.2575 e - 01 & A 6 = 6.27068 e - 01 & A 8 = - 1.60141 e + 00\end{matrix} \\ A 10 = 1.82728 e + 00\end{matrix}$$

$$\begin{matrix}6 th Surface \\ \begin{matrix}K = 2.6601 e + 00 & A 4 = - 3.37434 e - 01 & A 6 = - 2.07792 e - 01 & A 8 = 1.03514 e + 00\end{matrix} \\ \begin{matrix}A 10 = - 1.74754 e + 00 & A 12 = 1.26306 e + 00 & A 14 = - 1.36633 e - 01 & A 16 = - 8.95322 e - 02\end{matrix}\end{matrix}$$

$$\begin{matrix}7 th Surface \\ \begin{matrix}K = 2.89242 e + 01 & A 4 = - 3.42912 e - 01 & A 6 = 1.98866 e - 01 & A 8 = - 9.0727 e - 02\end{matrix} \\ \begin{matrix}A 10 = 7.20873 e - 03 & A 12 = 8.78904 e - 03 & A 14 = - 1.68521 e - 03\end{matrix}\end{matrix}$$

$$\begin{matrix}8 th Surface \\ \begin{matrix}K = - 5.53855 e + 00 & A 4 = 5.40644 e - 03 & A 6 = 7.17144 e - 03 & A 8 = - 6.11534 e - 04\end{matrix} \\ \begin{matrix}A 10 = 3.80971 e - 04 & A 12 = - 1.54203 e - 04\end{matrix}\end{matrix}$$

$$\begin{matrix}9 th Surface \\ \begin{matrix}K = - 1.10259 e + 01 & A 4 = - 7.33408 e - 02 & A 6 = - 2.34943 e - 02 & A 8 = - 1.14536 e - 03\end{matrix} \\ \begin{matrix}A 10 = 1.23043 e - 04 & A 12 = - 8.25915 e - 05\end{matrix}\end{matrix}$$

VARIOUS DATA

| | |
|---|---|
| Focal Length | 5.53 |
| Fno | 2.50 |
| Half Angle of View (°) | 26.20 |
| Image Height | 2.72 |
| Overall Lens Length | 4.59 |
| BF | 0.57 |
| Entrance Pupil Position | 1.73 |
| Exit Pupil Position | −2.19 |
| Front Principal-Point Position | −4.53 |
| Rear Principal-Point Position | −5.13 |

SINGLE LENS DATA

| | Starting | Focal |
|---|---|---|
| Lens | Surface | Length |
| 1 | 1 | 3.00 |
| 2 | 4 | −8.98 |
| 3 | 6 | −3.37 |
| 4 | 8 | −64.19 |

### NUMERICAL EXAMPLE 3

UNIT: mm
SURFACE DATA

| | | | | | Effective |
|---|---|---|---|---|---|
| Surface No. | r | d | nd | vd | Diameter |
| 1* | 2.226 | 0.83 | 1.43875 | 94.9 | 3.00 |
| 2 (diffraction) | ∞ | 1.43 | | | 2.87 |
| 3 (SP) | ∞ | 0.10 | | | 1.86 |
| 4* | −9.383 | 0.30 | 1.58172 | 30.3 | 1.77 |
| 5* | 7.917 | 2.01 | | | 1.56 |
| 6* | −8.482 | 0.40 | 1.53504 | 55.7 | 2.53 |
| 7* | 5.062 | 0.15 | | | 3.12 |
| 8 | −3.299 | 1.00 | 1.63648 | 19.7 | 3.52 |
| 9* | −2.221 | 0.51 | | | 4.19 |
| 10 | ∞ | 0.21 | 1.51633 | 64.1 | 5.50 |
| 11 | ∞ | 0.40 | | | 5.50 |
| Image Plane | ∞ | | | | |

### Aspheric Data

$$\begin{matrix}1 st Surface \\ \begin{matrix}K = 3.28784 e - 01 & A 4 = - 1.12717 e - 02 & A 6 = - 1.16474 e - 03 & A 8 = - 5.88116 e - 04\end{matrix} \\ A 10 = - 7. 58421 e - 05\end{matrix}$$

$$\begin{matrix}2 nd Surface ( Diffractive surface ) \\ \begin{matrix}Designed Wavelength & 0.58756 [ μm ]\end{matrix} \\ \begin{matrix}U 2 = - 1.24211 e - 02 & U 4 = - 9.93242 e - 04 & U 6 = 1.10002 e - 03 & U 8 = - 5.79917 e - 04 \\ U 10 = 1.48671 e - 04 & & & \end{matrix}\end{matrix}$$

### Optical Path Difference Dispersion of Surface

$$P ( λ ) = 11.97801 \cdot {λ}^{10} - 113.77083 \cdot {λ}^{9} + 647.33 \; 574 \cdot {λ}^{8} - 2448.35587 \cdot {λ}^{7} + 6465.34198 \cdot {λ}^{6} - 12165.39383 \cdot {λ}^{5} + 16315.44261 \cdot {λ}^{4} - 15288.8875 \cdot {λ}^{3} + 953 \; 8.09 \; 656 \cdot {λ}^{2} - 3567.44 \; 539 \cdot λ + 60 \; 6 \text{.61668}$$

$$\begin{matrix}P ( {λ}_{d} ) = 1. e + 00 \\ P ( {λ}_{C} ) = 9.046900 e - 01 \\ P ( {λ}_{F} ) = 1.196528 e + 00\end{matrix}$$

$$\begin{matrix}4 th Surface \\ \begin{matrix}K = - 7.12739 e + 02 & A 4 = 1.93928 e - 02 & A 6 = 3. 10222 e - 01 & A 8 = - 9.88060 e - 01\end{matrix} \\ \begin{matrix}A 10 = 2. 3483 e + 00 & A 12 = - 2. 53536 e + 00 & A 14 = 171781 e + 00 & A 16 = - 4. 81247 e - 01\end{matrix}\end{matrix}$$

$$\begin{matrix}5 th Surface \\ \begin{matrix}K = 7.49263 e + 01 & A 4 = 1.33691 e - 01 & A 6 = - 4.90895 e - 02 & A 8 = 7. 52699 e - 02\end{matrix} \\ A 10 = - 6.37695 e - 02\end{matrix}$$

$$\begin{matrix}6 th Surface \\ \begin{matrix}K = 4. 03729 e + 01 & A 4 = - 2.72142 e - 01 & A 6 = - 1.27746 e - 01 & A 8 = 8. 56983 e - 01\end{matrix} \\ \begin{matrix}A 10 = - 1.3686 e + 00 & A 12 = 1.08218 e + 00 & A 14 = - 4.25757 e - 01 & A 16 = 6.72854 e - 02\end{matrix}\end{matrix}$$

$$\begin{matrix}7 th Surface \\ \begin{matrix}K = 8.34119 e + 00 & A 4 = - 3.52878 e - 01 & A 6 = 2.40338 e - 01 & A 8 = - 1.18592 e - 01\end{matrix} \\ \begin{matrix}A 10 = 2.59296 e - 02 & A 12 = 1.53307 e - 03 & A 14 = - 1.08217 e - 03\end{matrix}\end{matrix}$$

$$\begin{matrix}8 th Surface \\ \begin{matrix}K = 2. 04857 e + 00 & A 4 = 3.67846 e - 02 & A 6 = 4. 39495 e - 03 & A 8 = - 1.50198 e - 03\end{matrix} \\ \begin{matrix}A 10 = 2.19341 e - 04 & A 12 = 1.74466 e - 05\end{matrix}\end{matrix}$$

$$\begin{matrix}9 th Surface \\ \begin{matrix}K = - 8.24113 e - 02 & A 4 = 3.88049 e - 02 & A 6 = 2.10572 e - 03 & A 8 = - 1.59372 e - 03\end{matrix} \\ \begin{matrix}A 10 = 3.89306 e - 04 & A 12 = - 3.30176 e - 05\end{matrix}\end{matrix}$$

VARIOUS DATA

| | |
|---|---|
| Focal Length | 8.70 |
| Fno | 2.90 |
| Half Angle of View (°) | 17.36 |
| Image Height | 2.72 |
| Overall Lens Length | 7.27 |
| BF | 1.05 |
| Entrance Pupil Position | 3.46 |
| Exit Pupil Position | −5.58 |
| Front Principal-Point Position | −0.50 |
| Rear Principal-Point Position | −8.30 |

SINGLE LENS DATA

| | Starting | Focal |
|---|---|---|
| Lens | Surface | Length |
| 1 | 1 | 4.56 |
| 2 | 4 | −7.33 |
| 3 | 6 | −5.86 |
| 4 | 8 | 7.85 |

### NUMERICAL EXAMPLE 4

UNIT: mm
SURFACE DATA

| | | | | | Effective |
|---|---|---|---|---|---|
| Surface No. | r | d | nd | vd | Diameter |
| 1* | 2.246 | 0.81 | 1.43875 | 94.9 | 2.96 |
| 2 (diffraction) | −295.185 | 1.41 | | | 2.83 |
| 3 (SP) | ∞ | 0.10 | | | 1.87 |
| 4* | −17.662 | 0.30 | 1.56422 | 36.5 | 1.77 |
| 5* | 6.188 | 1.99 | | | 1.56 |
| 6* | −6.412 | 0.40 | 1.53504 | 55.7 | 2.52 |
| 7* | 5.517 | 0.33 | | | 3.11 |
| 8* | −4.293 | 1.00 | 1.61957 | 22.1 | 3.65 |
| 9* | −2.411 | 0.28 | | | 4.28 |
| 10 | ∞ | 0.21 | 1.51633 | 64.1 | 5.50 |
| 11 | ∞ | 0.40 | | | 5.50 |
| Image Plane | ∞ | | | | |

### Aspheric Data

$$\begin{matrix}1 st Surface \\ \begin{matrix}K = 2. 78962 e - 01 & A 4 = - 9.97081 e - 03 & A 6 = - 1.16477 e - 03 & A 8 = - 6.47121 e - 04\end{matrix} \\ A 10 = - 2. 00577 e - 07\end{matrix}$$

$$\begin{matrix}2 nd Surface ( Diffractive surface ) \\ K = 2. 28097 e + 04 \\ \begin{matrix}Designed Wavelength & 0.58756 [ μm ]\end{matrix} \\ \begin{matrix}U 2 = - 1.21838 e - 02 & U 4 = 1.6305 e - 04 & U 6 = 2. 16299 e - 04 & U 8 = - 1.70898 e - 04\end{matrix} \\ U 10 = 7.75164 e - 05\end{matrix}$$

### Optical Path Difference Dispersion of Surface

$$P ( λ ) = - 43 \; 4.73 \; 044 \cdot {λ}^{10} + 8122.08 \; 910 \cdot {λ}^{9} - 6739 \; 4.74 \; 965 \cdot {λ}^{8} + 329209.06 \; 586 \cdot {λ}^{7} - 1049750.44998 \cdot {λ}^{6} + 2284260.64 \; 803 \cdot {λ}^{5} - 3435917.19 \; 850 \cdot {λ}^{4} + 3528102.09 \; 277 \cdot {λ}^{3} - 2367044.44 179 \cdot {λ}^{2} + 937 29.43 952 \cdot λ - 166209.30017$$

$$\begin{matrix}P ( {λ}_{d} ) = 1. e + 00 \\ P ( {λ}_{C} ) = 9.218523 e - 01 \\ P ( {λ}_{F} ) = 1.177345 e + 00\end{matrix}$$

$$\begin{matrix}4 th Surface \\ \begin{matrix}K = - 3.9437 e + 03 & A 4 = 3.63831 e - 02 & A 6 = 3.04246 e - 01 & A 8 = - 1.00699 e + 00\end{matrix} \\ \begin{matrix}A 10 = 2.05779 e + 00 & A 12 = - 2.51896 e + 00 & A 14 = 1.67922 e + 00 & A 16 = - 4.64464 e - 01\end{matrix}\end{matrix}$$

$$\begin{matrix}5 th Surface \\ \begin{matrix}K = 4.21306 e + 01 & A 4 = 1. 19464 e - 01 & A 6 = - 1.17085 e - 02 & A 8 = 4. 56339 e - 03\end{matrix} \\ A 10 = - 1.28123 e - 02\end{matrix}$$

$$\begin{matrix}6 th Surface \\ \begin{matrix}K = 2.25807 e + 01 & A 4 = - 2.40989 e - 01 & A 6 = - 1.20292 e - 01 & A 8 = 8.48864 e - 01\end{matrix} \\ \begin{matrix}A 10 = - 1.36495 e + 00 & A 12 = 1.07826 e + 00 & A 14 = - 4.25456 e - 01 & A 16 = 6.78933 e - 02\end{matrix}\end{matrix}$$

$$\begin{matrix}7 th Surface \\ \begin{matrix}K = 1.01704 e + 01 & A 4 = - 3.33795 e - 01 & A 6 = 2. 36754 e - 01 & A 8 = - 1.18145 e - 01\end{matrix} \\ \begin{matrix}A 10 = 2.50599 e - 02 & A 12 = 1.71424 e - 03 & A 14 = - 1.0542 e - 03\end{matrix}\end{matrix}$$

$$\begin{matrix}8 th Surface \\ \begin{matrix}K = 3.74014 e + 00 & A 4 = - 3.44508 e - 03 & A 6 = 1. 14067 e - 02 & A 8 = - 2.17872 e - 03\end{matrix} \\ \begin{matrix}A 10 = 4.85615 e - 04 & A 12 = - 5.30278 e - 05\end{matrix}\end{matrix}$$

$$\begin{matrix}9 th Surface \\ \begin{matrix}K = 3.93746 e - 02 & A 4 = 2.66395 e - 02 & A 6 = - 1.24811 e - 03 & A 8 = 1.05063 e - 04\end{matrix} \\ \begin{matrix}A 10 = 1.52986 e - 04 & A 12 = - 2.06204 e - 05\end{matrix}\end{matrix}$$

VARIOUS DATA

| | |
|---|---|
| Focal Length | 8.58 |
| Fno | 2.90 |
| Half Angle of View (°) | 17.59 |
| Image Height | 2.72 |
| Overall Lens Length | 7.15 |
| BF | 0.81 |
| Entrance Pupil Position | 3.34 |
| Exit Pupil Position | −5.71 |
| Front Principal-Point Position | −0.13 |
| Rear Principal-Point Position | −8.18 |

SINGLE LENS DATA

| | Starting | Focal |
|---|---|---|
| Lens | Surface | Length |
| 1 | 1 | 4.61 |
| 2 | 4 | −8.09 |
| 3 | 6 | −5.48 |
| 4 | 8 | 7.37 |

### NUMERICAL EXAMPLE 5

UNIT: mm
SURFACE DATA

| | | | | | Effective |
|---|---|---|---|---|---|
| Surface No. | r | d | nd | vd | Diameter |
| 1* | 1.679 | 0.81 | 1.43875 | 94.9 | 2.51 |
| 2 (diffraction) | −1201.658 | 0.80 | | | 2.37 |
| 3 (SP) | ∞ | 0.10 | | | 1.76 |
| 4* | −9.679 | 0.30 | 1.60444 | 24.8 | 1.65 |
| 5* | 7.743 | 1.84 | | | 1.40 |
| 6* | −2.952 | 0.40 | 1.53504 | 55.7 | 2.57 |
| 7* | 11.054 | 0.11 | | | 3.28 |
| 8* | −1.909 | 0.75 | 1.64475 | 19.1 | 3.74 |
| 9* | −1.431 | 0.03 | | | 4.10 |
| 10 | ∞ | 0.21 | 1.51633 | 64.1 | 5.50 |
| 11 | ∞ | 0.40 | | | 5.50 |
| Image Plane | ∞ | | | | |

### Aspheric Data

$$\begin{matrix}1 st Surface \\ \begin{matrix}K = - 8.31081 e - 01 & A 4 = 9. 86364 e - 03 & A 6 = - 4.96299 e - 04 & A 8 = 2. 14642 e - 03\end{matrix} \\ A 10 = - 8.10108 e - 04\end{matrix}$$

$$\begin{matrix}2 nd Surface ( Diffractive surface ) \\ K = 8. 39004 e + 05\end{matrix}$$

$$\begin{matrix}\begin{matrix}Designed Wavelength & 0.58756 [ μm ]\end{matrix} \\ \begin{matrix}U 2 = - 9.57924 e - 03 & U 4 = 1.96827 e - 03 & U 6 = 1.84008 e - 03 & U 8 = - 1.04244 e - 03 \\ U 10 = 1.26614 e - 04 & & & \end{matrix}\end{matrix}$$

### Optical Path Difference Dispersion of Surface

$$P ( λ ) = 0.58 \; 756 / λ$$

$$\begin{matrix}P ( {λ}_{d} ) = 1. e + 00 \\ P ( {λ}_{C} ) = 8.953022 e - 01 \\ P ( {λ}_{F} ) = 1.208648 e + 00\end{matrix}$$

$$\begin{matrix}4 th Surface \\ \begin{matrix}K = - 7.78980 e + 02 & A 4 = 1. 13646 e - 01 & A 6 = 2. 67771 e - 01 & A 8 = - 1.0235 e + 00\end{matrix} \\ \begin{matrix}A 10 = 2.21155 e + 00 & A 12 = - 2.77374 e + 00 & A 14 = 1.79686 e + 00 & A 16 = - 4.32428 e - 01\end{matrix}\end{matrix}$$

$$\begin{matrix}5 th Surface \\ \begin{matrix}K = 9. 50000 e + 01 & A 4 = 2. 51941 e - 01 & A 6 = - 1.04642 e - 01 & A 8 = 1.91332 e - 01\end{matrix} \\ \begin{matrix}A 10 = - 2.07083 e - 01 & & & \end{matrix}\end{matrix}$$

$$\begin{matrix}6 th Surface \\ \begin{matrix}K = 3.75305 e + 00 & A 4 = - 3.17027 e - 01 & A 6 = - 1.36568 e = - 01 & A 8 = 1.09289 e + 00\end{matrix} \\ \begin{matrix}A 10 = - 1.59737 e + 00 & A 12 = 1.13434 e + 00 & A 14 = - 4.07143 e - 01 & A 16 = 6.08155 e - 02\end{matrix}\end{matrix}$$

$$\begin{matrix}7 th Surface \\ \begin{matrix}K = 4. 7551 e + 01 & A 4 = - 3.64478 e - 01 & A 6 = 2. 85375 e - 01 & A 8 = - 1.3395 e - 01\end{matrix} \\ \begin{matrix}A 10 = 3.0196 e - 02 & A 12 = - 2.92272 e - 03 & A 14 = 1.40925 e - 04 & \end{matrix}\end{matrix}$$

$$\begin{matrix}8 th Surface \\ \begin{matrix}K = - 8.37675 e + 00 & A 4 = 2. 02048 e - 02 & A 6 = - 1.49159 e - 02 & A 8 = 1.26993 e - 03\end{matrix} \\ \begin{matrix}A 10 = 1.53299 e - 03 & A 12 = - 3.05658 e - 04 & & \end{matrix}\end{matrix}$$

$$\begin{matrix}9 th Surface \\ \begin{matrix}K = - 3.76863 e + 00 & A 4 = - 2.11771 e - 03 & A 6 = - 2.28008 e - 03 & A 8 = - 3.46988 e - 03\end{matrix} \\ \begin{matrix}A 10 = 2.0788 e - 03 & A 12 = - 2.72202 e - 04 & & \end{matrix}\end{matrix}$$

VARIOUS DATA

| | |
|---|---|
| Focal Length | 6.79 |
| Fno | 2.70 |
| Half Angle of View (°) | 21.83 |
| Image Height | 2.72 |
| Overall Lens Length | 5.69 |
| BF | 0.57 |
| Entrance Pupil Position | 2.16 |
| Exit Pupil Position | −5.42 |
| Front Principal-Point Position | 1.02 |
| Rear Principal-Point Position | −6.39 |

SINGLE LENS DATA

| | Starting | Focal |
|---|---|---|
| Lens | Surface | Length |
| 1 | 1 | 3.60 |
| 2 | 4 | −7.07 |
| 3 | 6 | −4.31 |
| 4 | 8 | 5.50 |

TABLE 1

| | | Numerical Example | | | | |
|---|---|---|---|---|---|---|
| | | 1 | 2 | 3 | 4 | 5 |
| Inequality | (1) | −0.0235 | −0.0429 | −0.0205 | −0.0556 | 0.0000 |
| | (2) | 0.5314 | 0.5427 | 0.5247 | 0.5374 | 0.5298 |
| | (3) | 7.5418 | 9.0305 | 4.6269 | 4.8001 | 7.5435 |
| | (4) | 0.8483 | 0.8430 | 0.8437 | 0.8422 | 0.8483 |
| | (5) | 0.1610 | 0.1450 | 0.2070 | 0.2085 | 0.1568 |
| | (6) | 0.3154 | 0.2509 | 0.2738 | 0.2757 | 0.3203 |
| | (7) | 0.3013 | 0.3116 | 0.3210 | 0.3211 | 0.2977 |
| | (8) | −0.6509 | −0.6095 | −0.6741 | −0.6386 | −0.6349 |

### Image Pickup Apparatus

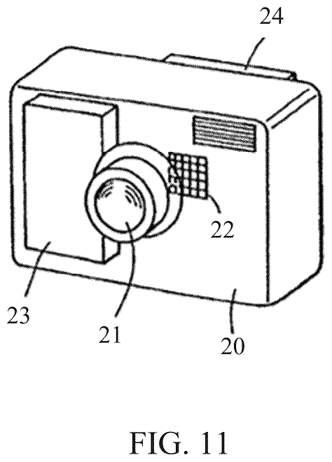

FIG. 11 illustrates a digital still camera as an image pickup apparatus using the optical system according to any one of the above examples as an imaging optical system. Reference numeral 20 denotes a camera body, and reference numeral 21 denotes an imaging optical system including any of the optical systems according to Examples 1 to 5. Reference numerals 22 denotes an image sensor such as a CCD sensor or CMOS sensor that is built in the camera body 20 and configured to capture an optical image (object image) formed by the imaging optical system 21. Reference numeral 23 denotes a recorder configured to record image data generated by processing an imaging signal from the image sensor 22, and reference numeral 24 denotes a rear display unit configured to display image data.

The optical system according to each example can provide a camera having a reduced size and high optical performance. The camera may be a single-lens reflex camera with a quick-turn mirror, or a mirrorless camera without a quick-turn mirror.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical system having a reduced size and high optical performance using a diffractive surface having a controlled wavelength dispersion characteristic.

This application claims priority to Japanese Patent Application No. 2023-140612, which was filed on Aug. 31, 2023, and which is hereby incorporated by reference herein in its entirety.

What is claimed is:

1. An optical system comprising, in order from an object side to an image side:
a diffractive optical element having positive refractive power, and a diffractive surface with a controlled wavelength dispersion characteristic; and
a lens having negative refractive power,
wherein where ν₀ is an Abbe number of the diffractive surface, a reference wavelength is d-line, primary dispersion is F-line and C-line, Ψ(λ_{d}), Ψ(λ_{F}), and Ψ(λ_{C}) are optical path difference functions for the d-line, the F-line, and the C-line, respectively, P(λ_{d}), P(λ_{F}), and P(λ_{C}) are optical path difference dispersions of a surface for the d-line, the F-line, and the C-line, respectively, the following equation is satisfied:
$$\frac{1}{{v}_{o}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} ,$$
and the following inequality is satisfied:
$$- 0.2 < 1 / {v}_{0} < 0.2 .$$

2. The optical system according to claim 1, wherein the diffractive optical element has a convex refractive surface on the object side.

3. The optical system according to claim 1, wherein the diffractive surface is disposed on the image side of the diffractive optical element.

4. The optical system according to claim 1, wherein the following inequality is satisfied:
$$0.3 < f l / f < 0.8$$
where f1 is a focal length of the diffractive optical element, and f is a focal length of the optical system.

5. The optical system according to claim 1, wherein the following equation is satisfied:
$$\frac{1}{{f}_{moe}} = - 2 {U}_{2}$$
where fₘₒₑ is a focal length of the diffractive surface, and U₂ is a quadratic coefficient of an optical path difference function of a surface at a design wavelength, and
the following inequality is satisfied:
$$2.5 < {f}_{m o e} / f < 10.0$$
where f is a focal length of the optical system.

6. The optical system according to claim 1, wherein the following inequality is satisfied:
$$0.6 < TL / f < 0.9$$
where TL is a distance on an optical axis from a lens surface closest to an object of the optical system to an image plane, and f is a focal length of the optical system.

7. The optical system according to claim 1, wherein a first optical element serves as the diffractive optical element and is disposed closest to an object, and a second optical element serves as the lens.

8. The optical system according to claim 7, wherein the following inequality is satisfied:
$$0.08 < D 12 / TL < 0.40$$
where D12 is an air gap on an optical axis between the first optical element and the second optical element, and TL is a distance on an optical axis from a lens surface closest to the object of the optical system to an image plane.

9. The optical system according to claim 7, further comprising a third optical element as a lens disposed on the image side of and adjacent to the second optical element,
wherein the following inequality is satisfied:
$$0.15 < D 23 / TL < 0.50$$
where D23 is an air gap on an optical axis between the second optical element and the third optical element, and TL is a distance on the optical axis from a lens surface closest to the object of the optical system to an image plane.

10. The optical system according to claim 7, wherein the following inequality is satisfied:
$$0. 20 < L 02 / TL < 0.45$$
where L02 is a distance on an optical axis from a lens surface closest to the object of the optical system to a lens surface closest to the object of the second optical element, and TL is a distance on the optical axis from the lens surface closest to the object of the optical system to an image plane.

11. The optical system according to claim 7, wherein the optical system has a third optical element as a lens having negative refractive power disposed on the image side of and adjacent to the second optical element, and
wherein the following inequality is satisfied:
$$- 1.5 < fG 3 / f < - 0.4$$
where fG3 is a focal length of the third optical element, and f is a focal length of the optical system.

12. The optical system according to claim 1, further comprising, in order from the object side to the image side,
a first optical element as the diffractive optical element disposed closest to an object;
a second optical element as the lens;
a third optical element having aspheric surfaces on both sides; and
a fourth optical element having aspheric surfaces on both sides.

13. The optical system according to claim 12, wherein the third optical element has negative refractive power, and
wherein the fourth optical element has positive or negative refractive power.

14. An optical system comprising, in order from an object side to an image side:
a metalens having positive refractive power, and a metasurface with a controlled wavelength dispersion characteristic; and
a lens having negative refractive power,
wherein where vo is an Abbe number of the metasurface, a reference wavelength is d-line, primary dispersion is F-line and C-line, Ψ(λ_{d}), Ψ(λ_{F}), and Ψ(λ_{C}) are optical path difference functions for the d-line, the F-line, and the C-line, respectively, P(λ_{d}), P(λ_{F}), and P(λ_{C}) are optical path difference dispersions of a surface for the d-line, the F-line, and the C-line, respectively, the following equation is satisfied:
$$\frac{1}{{v}_{o}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} , 1$$
and the following inequality is satisfied:
$$- 0.2 < 1 / {v}_{0} < 0.2 .$$

15. The optical system according to claim 14, wherein the metalens has a convex refractive surface on the object side.

16. The optical system according to claim 14, wherein the metasurface is disposed on the image side of the metalens.

17. An image pickup apparatus comprising:
the optical system according to claim 1; and
an image sensor configured to capture an object image through the optical system.

18. An image pickup apparatus comprising:
the optical system according to claim 14; and
an image sensor configured to capture an object image through the optical system.
